(19) United States
(12) Patent Application Publication
(10) Pub. No.: US 2010/0109504 A1
(43) Pub. Date: May 6, 2010

(54) STARTING COIL FOR INDUCTION LIGHTING

(75) Inventors: Jianwu Li, Solon, OH (US); Andrew Lawrence Podevels, University Heights, OH (US); Paul M. Kuester, Shaker Heights, OH (US)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/609,042

(22) Filed: Oct. 30, 2009

Related U.S. Application Data
(60) Provisional application No. 61/110,349, filed on Oct. 31, 2008.

(51) Int. Cl. H01J 1/50

(52) U.S. Cl. 313/161; 315/248

(57) ABSTRACT

Life of a starting conductor or coil in an induction lamp is significantly improved with the present disclosure. A mechanical support supports the starting coil adjacent the arc body of the lamp and has features that allow the starting coil to mount thereon. The mechanical support may be made of a high temperature material such as glass, quartz, or ceramic so that light from the lamp is not blocked. In another embodiment, the starting conductor is protected from oxidation by fully encasing the starting conductor within the high temperature material. In still another embodiment, a thin coating of a high temperature material that may or may not be light transmissive could be used as an alternative manner of support.

### BACKGROUND OF THE DISCLOSURE

This application claims priority from U.S. provisional application Ser. No. 61/110,349, filed 31 Oct. 2008, the entire disclosure of which is hereby expressly incorporated herein by reference.

This application relates to a high intensity discharge (HID) lamp, and particularly to an electrodeless or induction HID lamp, and more particularly to an electrodeless or induction ceramic HID lamp.

In induction lighting, a helical electrically conductive starting coil is sometimes used to initiate a capacitive discharge then a toroidal plasma inside the lamp is maintained by a main coil surrounding the lamp. The starting coil must be positioned close to the lamp and as a result the temperature increases from ambient temperature to several hundred degrees Celsius when the lamp is operating. These temperature extremes, or thermal cycling, will ultimately cause the starting coil to lose mechanical strength and sag. If the individual turns of the helical starting coil were to touch each other, an electrically closed loop would be formed and a high current would be induced in the starting coil. High current may potentially damage the starting coil. An electrically closed loop in the starting coil will weaken the capacitive discharge and fail to initiate a toroidal plasma inside the lamp.

Another issue with the starting coil is that over time the coil is subject to oxidation. The high temperature associated with lamp operation will expedite the oxidation of the starting coil and reduce the useful working life of the starting coil. Unfortunately, this reduced life is directly at odds with one of the major benefits associated with induction lighting, i.e., long life.

Accordingly, a need exists to significantly improve the life of a starting coil of an induction lighting assembly. As noted above, significant improvement is required on at least two fronts, namely mechanical support to address the loss of mechanical strength and associated sagging, and reducing the oxidation issue.

### SUMMARY OF THE DISCLOSURE

A primary advantage of the present disclosure resides in the ability to address the useful life of the starting coil.

A part of this advantage resides in the ability to adequately address the loss of mechanical strength associated with thermal cycling.

Another part of the advantage provided by the present disclosure relates to limiting oxidation of the starting coil.

Yet another advantage of the present disclosure resides in the limited impact on the light output of the lamp, while facilitating start-up or ignition of the main envelope.

Still another benefit is associated with the ease of assembly.

Still other benefits and advantages of the present disclosure will become apparent from reading and understanding the following detailed description.

### BRIEF DESCRIPTION OF THE DRAWINGS

FIG. 1 is a sectional view of an electrodeless discharge lamp.

FIGS. 2-6 are views of different embodiments for improving the life of the starting coil.

### DETAILED DESCRIPTION OF THE PREFERRED EMBODIMENTS

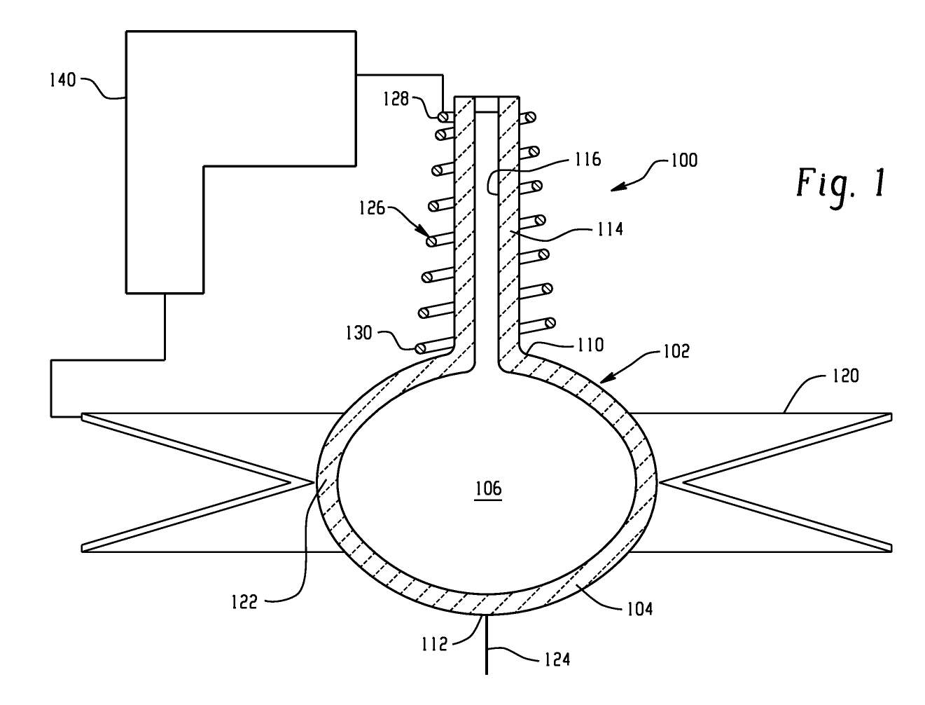

Turning first to FIG. 1, there is shown a lamp assembly and, more particularly, an electrodeless high intensity discharge (HID) or ceramic HID lamp assembly 100, that includes a main envelope or arc body 102. The arc body preferably has an ellipsoidal or generally spheroidal portion 104 that encloses a similarly shaped cavity or main chamber 106 housing a desired main fill therein. The main chamber is hermetically sealed from the external or ambient environment after the main fill has been introduced or dosed into the arc body. The arc body is preferably made from a ceramic material that is light transmissive such as a polycrystalline alumina, although other materials may be used where conducive to the demands or needs of the electrodeless lamp.

The generally spheroidal portion 104 of the arc body has first and second polar regions 110, 112. Extending outwardly from the first polar region 110 is an envelope extension or leg 114. The leg is preferably hollow and thereby defines a cavity or starting chamber 116 that communicates with the main chamber 106. The leg has a substantially smaller cross-sectional dimension than the spheroidal portion.

A radio frequency or RF coil 120, sometimes referred to as the main coil, extends about an equatorial or median region 122 of the arc body. The coil is preferably a multi-turn assembly such as the illustrated coil 120 that includes first and second turns, although a greater number of turns could be used if so desired. The coil preferably has a low profile and desirably does not significantly impact or block the light emitted from the main chamber. The main RF coil is closely disposed adjacent a perimeter of the equatorial region 122 of the spheroidal portion in order to provide energy to the fill and continue to power the arc discharge (toroidal-shaped discharge) once ignition of the main fill occurs.

A high voltage conductor or wire 124 extends from a high voltage power source (not shown) and terminates closely adjacent the second polar region 112 of the arc body. In addition, a starting member, starting conductor, or helical starting coil 126 has a first end 128 disposed adjacent a first or distal end of the leg 114. The helical starting coil preferably has a diameter closely dimensioned to the outer dimension or diameter of the leg distal end. In this arrangement, the starting coil 126 increases in diameter as the starting coil proceeds along the length of the leg toward the first polar region 110 of the arc body where a second end 130 of the starting coil abuts or is closely spaced from the first polar region 110 of the arc body. The first end 128 of the starting coil is connected to an LC resonant circuit which provides a start-up or ignition charge to the starting coil 128. The operation of the circuit is well known in the art so that further discussion herein is deemed unnecessary to understanding the present disclosure.

The high voltage conductor 124 provides approximately 10 kv of the required high voltage to ionize the fill in the main envelope. When the starting coil 126 voltage increases to about 2.5 kv via the LC resonant circuit, capacitive discharge is initiated and a toroidal plasma inside the lamp is started. Further power required for maintaining the discharge is then provided by the RF coil and as controlled by the resonant circuit 140.

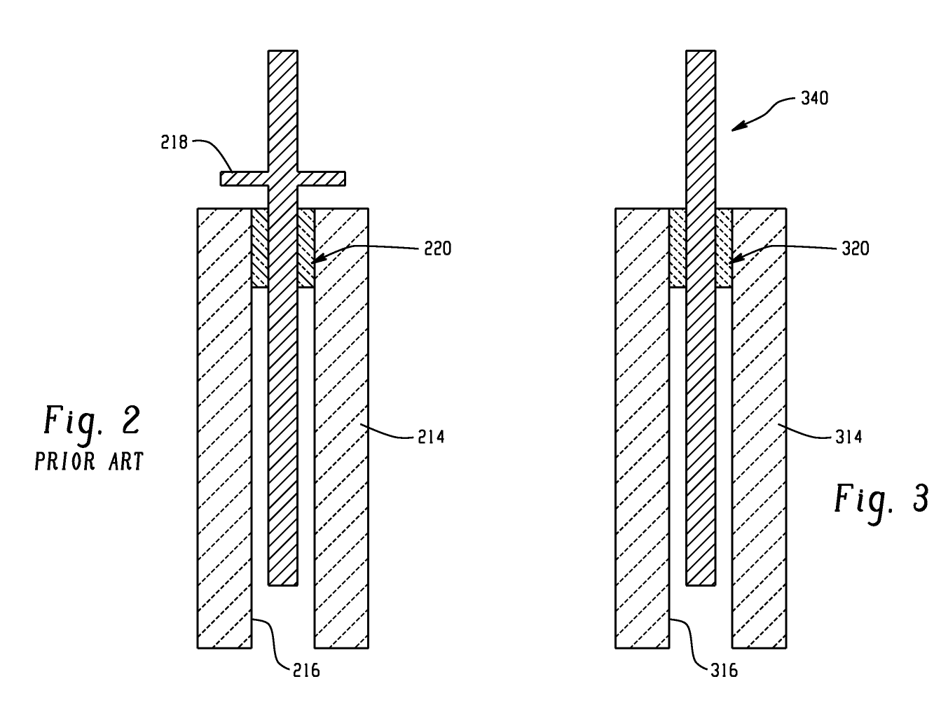

The helical starting coil of FIG. 1 increases in diameter from the top to the bottom, and the starting coil is relatively closely spaced to the leg. As noted in the Background, the high temperature and thermal cycling to which the starting coil is exposed indicates that increased support and protection is required. FIG. 2 is a first preferred arrangement in which a physical or mechanical support is provided for the starting coil. Although selected portions of the lamp assembly of FIG. 1 have been removed for ease of illustration and understanding, like reference numerals in the two hundred series (“200”) will be used to refer to similar components in FIG. 2, e.g., generally spheroidal portion 104 in FIG. 1 is now referenced as generally spheroidal portion 204 in FIG. 2. Likewise, new components will be referenced by new reference numerals. Support 250 is preferably a light transmissive material such as glass, quartz, or ceramic so that light from the lamp will not be adversely blocked by the support. However, in some applications the top surface of the lamp has a layer of coating to direct the light to a specific direction. In these applications, support 250 can be non-light transmissive material or low light absorptive material since the coating will reflect the light. The support has a generally cylindrical conformation with an inner diameter 252 slightly greater than the outer diameter of the leg 214 to define an annular gap or space 254. Although a cylindrical conformation is preferred to conform to the cylindrical conformation of the leg, it will also be appreciated that the support can adopt still other shapes or conformations, such as a cone shape with increasing diameter from a distal end of the leg toward the main envelope, without departing from the scope and intent of the present disclosure. A first or lower end 256 of the support either abuts or is positioned adjacent the interconnection between the leg and the spheroidal portion of the arc body. A second or upper end 258 of the support preferably terminates at or adjacent a terminal or distal end of the leg 214.

The support preferably includes means for mechanically supporting the starting coil 226, which is shown in FIG. 2 as having a helical, generally constant diameter along its longitudinal extent. Means for supporting the starting coil is a groove 270 in this preferred arrangement provided along the inner diameter 252 of the support where the groove is dimensioned to substantially conform to the diameter of the starting coil 226. As will be appreciated, if the starting coil 226 has a generally helical conformation, then the support means or internal grooves 270 in this embodiment likewise adopts a continuous, generally helical conformation along the inner surface of the support. Preferably, the groove has a generally C-shaped cross-sectional conformation to provide support over an extent greater than 180° of the outer surface of the starting coil. The inner surface 252 of the support and likewise the depth of the groove 270 are important to closely position the inner diameter of the starting coil adjacent but without contacting the outer surface of the arc body leg. Moreover, the support is also preferably formed from a material that can withstand the elevated temperature and thermal cycling associated with the lamp environment. Thus, the support is preferably a high temperature material (glass, quartz, or ceramic being preferred), and the support features along the inside surface of the support prevent the starting coil from mechanically sagging. To control the distance between the coil support 250 and lamp leg 214, orientation projections 280 can be added on the inner surface of the coil support such that the coil support 250 can move along the axis of the lamp leg 214 but not in the radial direction of the lamp leg 214. Also, the bottom surface of the coil support 250 can be shaped to conform to the top surface of the lamp. Although not believed to be as conducive to manufacturing, one skilled in the art will appreciate that the orientation projections may alternatively be formed on an external surface of the lamp leg. Likewise, the surface of the first polar region 210 can alternatively be shaped to conform to the bottom surface of the coil support 250.

FIG. 3 shows another preferred support where like components are referenced by like reference numerals in the three hundred series (“300”), e.g. a generally spheroidal portion 104 of FIG. 1 is referenced as generally spheroidal portion 304 in FIG. 3. The support 350 is again preferably formed of a high temperature material such as glass, quartz, or ceramic. Dimensioning of an inner surface or diameter 352 of the support is selected to provide an annular space or gap 354 around the outer surface or outer diameter of the arc body leg 314. The support has a first or lower end 356 that either abuts or rests on the generally spheroidal portion of the arc body at the upper polar region 310 or may be slightly spaced from the arc body if the support is otherwise held in place relative to the arc body. A second or upper end 358 of the support preferably terminates adjacent the distal end of the leg 314. Means for mechanically supporting the starter coil 326 is preferably an external groove 370. Since the starting coil 326 is a helix, then the groove 370 is preferably a continuous helical groove dimensioned to receive the starting coil therein. Again, the groove preferably has a cross-sectional conformation that provides the needed support for the starting coil. For example, a generally C-shaped conformation may be desired since that conformation provides support over slightly greater than one-half the outer surface of the starting coil. Of course, it will be recognized that the support groove 370 could adopt other shapes, although preferably the groove closely conforms to the outer surface of the starting coil to provide the desired mechanical support and prevent the starting coil from sagging. Similarly, to control the distance between the coil support 350 and lamp leg 314, orientation projections 380 can be added on the inner surface of the coil support (or alternatively can be added to an external surface of the lamp leg) such that the coil support 350 can move along the axis of the lamp leg 314 but not in the radial direction of the lamp leg 314. Also, the bottom surface of the coil support 350 and the top surface of the lamp can be shaped to conform to one another.

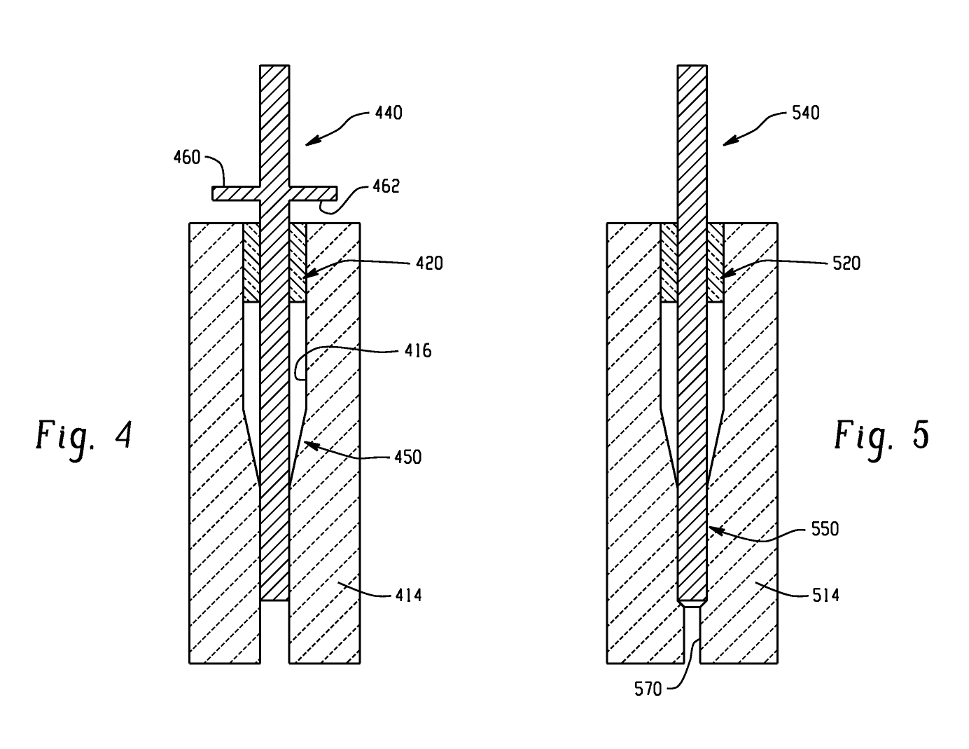

Another preferred embodiment of the support or means for supporting the starting coil is shown in FIG. 4. Again, for ease of reference, and brevity, reference numerals are provided in the four hundred series (“400”) to identify like components. In this embodiment, mechanical support 450 again adopts a generally cylindrical conformation where an inner surface or diameter 452 is slightly greater than that of the outer surface or outer diameter of the leg 414 to define an annular space or gap 454. The longitudinal extent of the support from a first or lower end 456 to a second or upper end 458 closely conforms to a longitudinal extent of the leg from the upper polar region 410 of the arc body 404. Again, preferred materials for the support include glass, quartz, or ceramic because of the light transmissive properties of these particular high temperature materials. A primary distinction of this embodiment relative to the supports described in FIGS. 2 and 3 is that the starting coil 426 is embedded or encased inside the support so that the starting coil is isolated from the ambient environment, i.e., air. This isolation reduces or eliminates concern with oxidation of the starting coil, while simultaneously providing the desired mechanical support that is necessary in this environment. Similarly, to control the distance between the coil support 450 and lamp leg 414, orientation projections 480 can be added on the inner surface of the coil support (or alternatively can be added to an external surface of the lamp leg) such that the coil support 450 can move along the axis of the lamp leg 414 but not in the radial direction of the lamp leg 414. Also, the bottom surface of the coil support 450 and the top surface of the lamp can be shaped to conform in to one another.

The embodiment of FIG. 5 bears similarities to the advantages offered by the FIG. 4 embodiment in that the starting coil 526 is not only mechanically supported by the support 550, but the starting coil is also protected against oxidation by being embedded or encased within the support material. A primary distinction is that the support of FIG. 5 is preferably bonded to the lamp leg 514. Stated another way, there is no gap between the support and the arc body leg as in the previously described embodiments. Rather, in FIG. 5 a thin layer of support material is provided over the leg 514 and the starting coil. Alternatively, the starting coil may be a thin layer of conductive material that is deposited on the lamp leg to form the helical conductor, i.e., the starting coil is formed or deposited in situ, instead of using a pre-formed helical metal wire joined to the leg with the layer of support material. However, in either event the support has sufficient thickness to mechanically support the starting coil 526 therein, and is also preferably thick enough to provide complete encapsulation and thereby protection from oxidation with the ambient environment.

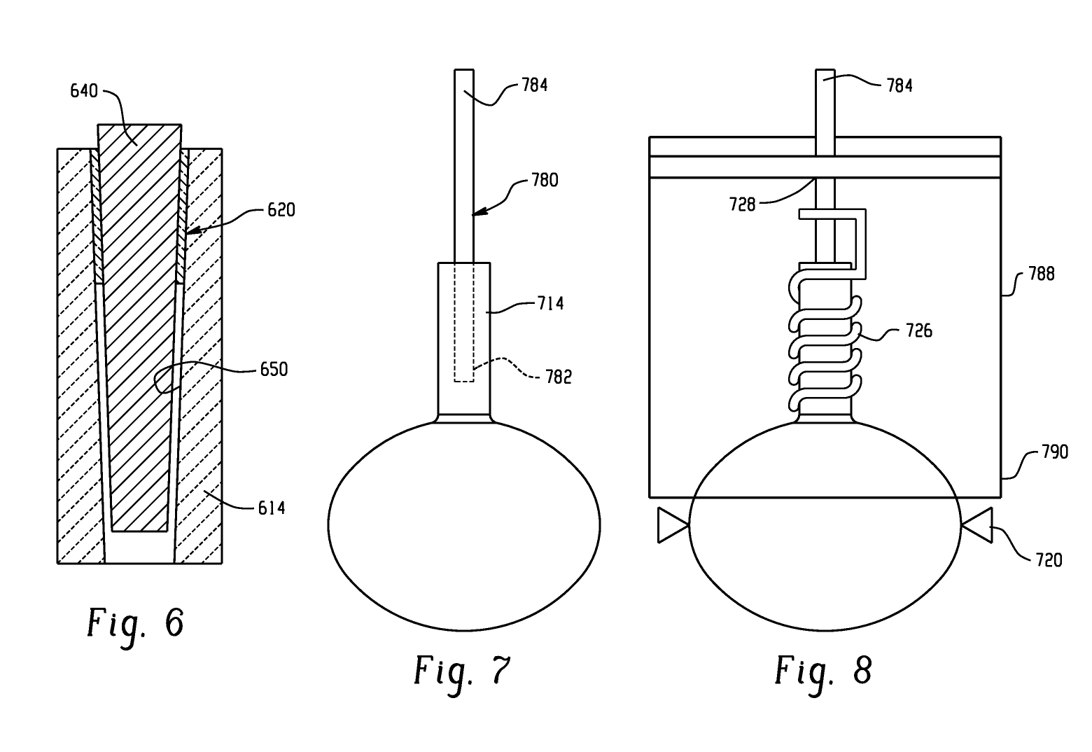

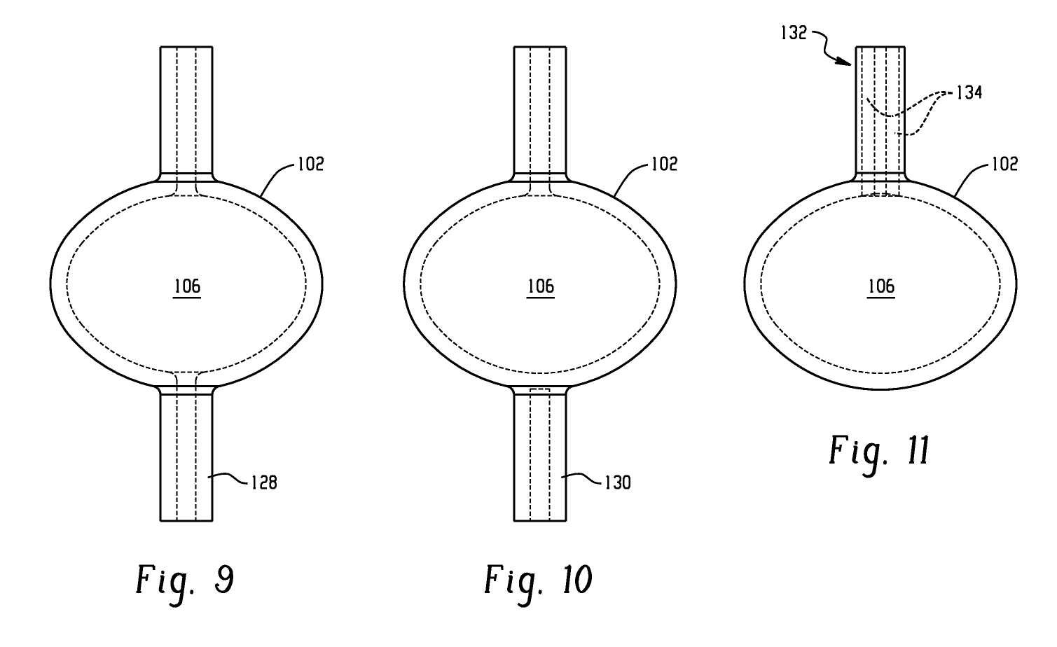

The embodiment of FIG. 6 provides a slightly different variation on the concept of providing mechanical support and protection against oxidation of the starting coil. Here, the starting coil 626 has a generally helical, extended pitch conformation and is shown as having a generally constant diameter as the starting coil extends along the length of the leg 614. The support 650 is a high temperature material that provides a thin coating about the entire surface of the starting conductor. The high temperature materials preferred for the support may be glass, quartz, ceramic, or similar light transmissive materials that are able to withstand the high temperatures associated with lamp operation. Alternatively, if the material is sufficiently thin coated, and since the starting coil is not a light transmissive material, consideration may be given to using a different (low light absorptive or non-light transmissive material) since the extended pitch provides openings between respective turns of the starting coil. Thus, alternative high temperature materials that are not light transmissive may be useful in this embodiment for non-coated lamp application, whereas non-light transmissive materials may not be as desirable for the previously described embodiments where the support is a structure that extends the entire height of the leg. This is not to suggest, however, that light transmissive, high temperature materials could not be used as the thin coating or support 650 around the starting coil in FIG. 6 that still leaves a substantial gap between the respective turns of the conductor to allow light to be transmitted therethrough. In coated lamp applications, support 650 can be low light absorptive material or non-light transmissive material since the coating will reflect the light.

The disclosure has been described with reference to the preferred embodiments. Obviously, modifications and alterations will occur to others upon reading and understanding the preceding detailed description. It is intended that the disclosure be construed as including all such modifications and alterations.

What is claimed is:

1. A high intensity discharge (HID) lamp comprising:
a main envelope having a chamber containing a gas fill that is selectively energized to produce a discharge and emit visible light from the main envelope;
an RF coil surrounding a light emitting portion of the main envelope;
a leg extending from the main envelope;
a starting conductor received around the leg for initiating a discharge in the lamp; and
a support for the starting conductor to prevent the starting conductor from sagging.

2. The HID lamp of claim 1 wherein the support is formed of a light transmissive material.

3. The HID lamp of claim 1 wherein the support is formed of a non-light transmissive material.

4. The HID lamp of claim 1 wherein the support is formed of a low light absorptive material.

5. The HID lamp of claim 1 wherein the support extends along an entire length of the starting conductor.

6. The HID lamp of claim 1 wherein the support has an inner surface dimensioned to form a gap with an outer surface of the leg.

7. The HID lamp of claim 1 wherein the support includes a groove dimensioned to receive the starting conductor.

8. The HID lamp of claim 1 further comprising radial projections extending between the support and the leg to center the support with the leg.

9. The HID lamp of claim 7 wherein the groove is located along an inner surface of the support.

10. The HID lamp of claim 7 wherein the groove is located along an outer surface of the support.

11. The HID lamp of claim 1 wherein the support encapsulates the starting conductor.

12. The HID lamp of claim 11 wherein the support includes a thin layer of material on the starting conductor.

13. The HID lamp of claim 12 wherein the starting conductor is a coil and the support has open spaces between adjacent turns of the coil.

14. The HID lamp of claim 12 wherein the thin layer of material is light transmissive.

15. The HID lamp of claim 12 wherein the thin layer of material is non-light transmissive.

16. The HID lamp of claim 12 wherein the thin layer of material is low light absorptive.

17. The HID lamp of claim 1 wherein the starting conductor has a tapered conformation that increases in diameter from a distal end of the leg toward the main envelope.

18. The HID lamp of claim 1 wherein the support abuts an outer surface of the leg.

19. An electrodeless ceramic metal halide (CMH) lamp comprising:
an electrodeless ceramic arc body having a spheroidal portion that contains a main fill that is selectively brought to a discharge state for emitting visible light therefrom, and a leg portion extending from a polar region of the spheroidal portion, the leg having a cross-sectional dimension substantially less than the arc body;
an annular induction coil disposed around the spheroidal portion for supplying power to maintain the discharge;
a starting coil operatively associated with the leg for initiating breakdown of the fill; and
a support for the starting coil to prevent the starting coil from sagging in response to thermal cycling.

20. The electrodeless CMH lamp of claim 19 wherein the support extends generally along the length of the leg and mechanically engages the starting coil.

21. The electrodeless CMH lamp of claim 20 wherein the support includes a groove that at least partially receives the starting coil.

22. The electrodeless CMH lamp of claim 21 wherein the groove receives a major portion of an outer surface of the starting coil.

23. The electrodeless CMH lamp of claim 21 wherein the groove is located on one of the inner and outer surfaces of the support.

24. The electrodeless CMH lamp of claim 19 wherein the support is formed of a light transmissive material.

25. The electrodeless CMH lamp of claim 19 wherein the support is formed of a non-light transmissive material.

26. The electrodeless CMH lamp of claim 19 wherein the support is formed of a low light absorptive material.

27. The electrodeless CMH lamp of claim 19 wherein the support encapsulates the starting coil to limit oxidation.

28. A high intensity discharge (HID) lamp comprising:
a main envelope having a chamber containing a gas fill that is selectively energized to produce a discharge and emit visible light from the main envelope;
an RF coil surrounding a light emitting portion of the main envelope;
a leg extending from the main envelope; and
a starting coil received around the leg and increasing in spaced dimension from the leg as the starting coil extends from a distal end of the leg toward the main envelope.
